(19) United States
(12) Patent Application Publication
(10) Pub. No.: US 2017/0019313 A1
(43) Pub. Date: Jan. 19, 2017

(54) A GENERIC MODEL TO IMPLEMENT A CLOUD COMPUTING SERVICE

(71) Applicant: HEWLETT PACKARD ENTERPRISE DEVELOPMENT LP, HOUSTON, TX (US)

(72) Inventors: Parag Doshi, Marietta, GA (US); Steven H. Marney, Lake Orion, MI (US); Chandra H. Kamalakantha, Plano, TX (US)

(73) Assignee: HEWLETT PACKARD ENTERPRISE DEVELOPMENT LP, HOUSTON, TX (US)

(21) Appl. No.: 15/104,205

(22) PCT Filed: Dec. 17, 2013
(86) PCT No.: PCT/US2013/075872

§ 371 Date: Jun. 13, 2016

(51) Int. Cl. H04L 12/24; H04L 12/911

(52) U.S. Cl. CPC H04L 41/5048; H04L 47/70; H04L 41/5096

(57) ABSTRACT

Example implementations relate to using a generic model to provision a computing resource to implement a cloud computing service. For example, a computing device may include a processor. The processor may generate a generic model of a cloud computing service. The generic model may be independent of a technology implementation of the cloud computing service. The processor may also generate a logical model of the cloud computing service based on the generic model. The processor may further provision a computing resource to implement the cloud computing service based on the logical model.

### BACKGROUND

Currently, a plurality of different cloud computing services exists. For example, Infrastructure-as-a-Service (IaaS) is a cloud computing service in which users are provided with access to computing resources, such as physical computing devices, virtual computing devices, or data storage. As another example, Software-as-a-Service (SaaS) is a cloud computing service in which users are provided with access to particular software hosted on a remote server, such as a web-based server.

### BRIEF DESCRIPTION OF THE DRAWINGS

Some examples of the present application are described with respect to the following figures:

FIG. 1 is a block diagram of an example computing device for provisioning a computing resource to implement a cloud computing service based on a generic model of the cloud computing service;

FIG. 2 is a block diagram of another example computing device for provisioning a computing resource to implement a cloud computing service based on a generic model of the cloud computing service;

FIG. 3 is an example of a flowchart illustrating a method of provisioning a computing resource to implement a cloud computing service based on a generic model of the cloud computing service;

FIG. 4A is a diagram of an example graphical user interface of a cloud computing service design application in which a generic model of a cloud computing service is displayed;

FIG. 4B is a diagram of an example graphical user interface of a cloud computing service design application in which a logical model of a cloud computing service is being generated based on the generic model of FIG. 4A;

FIG. 4C is a diagram of an example graphical user interface of a cloud computing service design application in which a logical model generated based on the generic model of FIG. 4A is displayed.

FIG. 4D is a diagram of an example physical implementation of the logical model of FIG. 4C;

FIG. 5A is a diagram of an example graphical user interface of a cloud computing service design application in which a generic model that is generated based on a first generic model and based on a second generic model is displayed;

FIG. 5B is a diagram of an example graphical user interface of a cloud computing service design application in which a logical model generated based on the generic model of 5A is displayed;

FIG. 6A is a diagram of an example graphical user interface of a cloud computing service design application in which a provisioning process of a cloud computing service is displayed;

FIG. 6B is a diagram of an example automated cloud computing service life cycle management interface; and

FIG. 6C is a diagram of an example build configuration file.

### DETAILED DESCRIPTION

As described above, a plurality of different cloud computing services exists. When a company is to deploy a particular cloud computing service, the particular cloud computing service may be deployed into a heterogeneous architecture based on the company's preference and/or access to technology. A heterogeneous architecture may be a deployment architecture where multiple technologies from different product vendors are used. For example, a heterogeneous architecture may include a cloud-based database server running an operation system from a first product vendor and a database product from a second product vendor. The heterogeneous architecture may also include a cloud-based application server running an operation system from a third product vendor and an application from a fourth product vendor.

In certain cases, a hybrid cloud architecture may be used as well. A hybrid cloud is a composition of two or more distinct cloud infrastructures, such as a private cloud, a public cloud, or a community cloud, that remain unique entities, but are bound together by standardized or proprietary technology that enables data and application portability. For example, the cloud-based database server may be hosted on a private cloud and the cloud-based application server may be hosted on a public cloud. Accordingly, each cloud computing service may have to be designed differently to suit a heterogeneous architecture. Thus, design complexity of a cloud computing service is increased.

Examples described herein address the above challenges by providing a reusable generic model of a cloud computing service that can be automatically provisioned into a heterogeneous architecture. For example, a cloud computing service designer may generate a generic model of a cloud computing service using a cloud computing service design application. The generic model may be independent of the underlying deployment architecture. Thus, the generic model may be reused for subsequent cloud computing service deployments as the generic model is not tied to any particular technology to be used to implement the cloud computing service. A logical model may then be generated based on the generic model. The logical model may correspond to a particular technology implementation of the cloud computing service. Based on the logical model, the cloud computing service designer may provision a computing resource, such as a physical computing device, a virtual computing device, or software, to implement the cloud computing service by using an automated cloud computing service life cycle management interface. In this manner, examples described herein may reduce a design complexity of a cloud computing service.

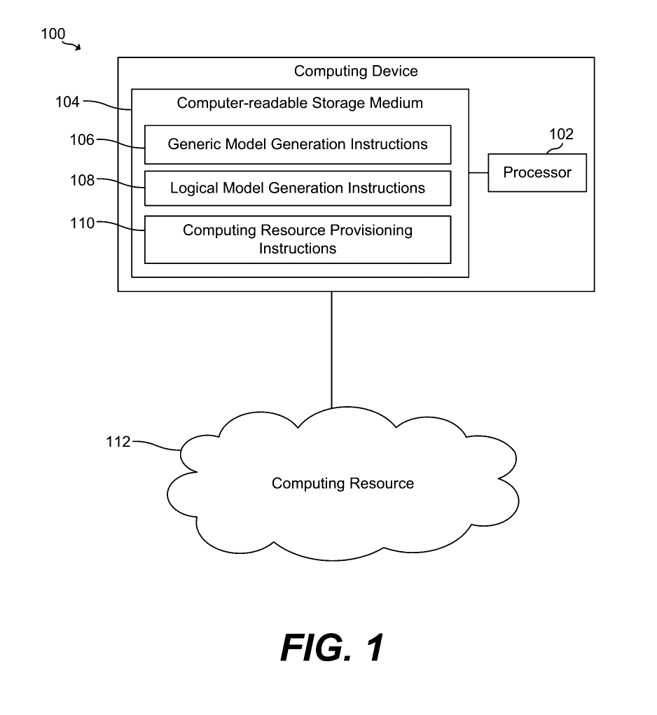

Referring now to the figures. FIG. 1 is a block diagram of an example computing device 100 for provisioning a computing resource to implement a cloud computing service based on a generic model of the cloud computing service. As used herein, a cloud computing service may be a network-based computational service that is provided to a user using physical computing devices, virtual computing devices, or a combination thereof. A cloud computing service may be provided via a cloud architecture, such as a private cloud, a public cloud, a hybrid cloud, a community cloud, or a combination thereof. A cloud computing service may include IaaS, Platform-as-a-Service (PaaS), SaaS, Network-as-a-Service (NaaS), or a combination thereof.

Computing device 100 may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to implement a cloud computing service based on a generic model of the cloud computing service. Computing device 100 may include a processor 102 and a computer-readable storage medium 104.

Processor 102 may be a central processing unit (CPU), a semiconductor-based microprocessor, and/or other hardware devices suitable for retrieval and execution of instructions stored in computer-readable storage medium 104. Processor 102 may fetch, decode, and execute instructions 106, 108, and 110 to control a process of provisioning a computing resource 112 to implement a cloud computing service based on a generic model. As an alternative or in addition to retrieving and executing instructions, processor 102 may include at least one electronic circuit that includes electronic components for performing the functionality of instructions 106, 108, 110, or a combination thereof.

Computer-readable storage medium 104 may be any electronic, magnetic, optical, or other physical storage device that contains or stores executable instructions. Thus, computer-readable storage medium 104 may be, for example, Random Access Memory (RAM), an Electrically Erasable Programmable Read-Only Memory (EEPROM), a storage device, an optical disc, etc. In some examples, storage medium 104 may be a non-transitory storage medium, where the term “non-transitory” does not encompass transitory propagating signals. As described in detail below, computer-readable storage medium 104 may be encoded with a series of processor executable instructions 106, 108, and 110 for generating a generic model, generating a logical model based on the generic model, and provisioning a computing resource to implement a cloud computing service based on the logical model.

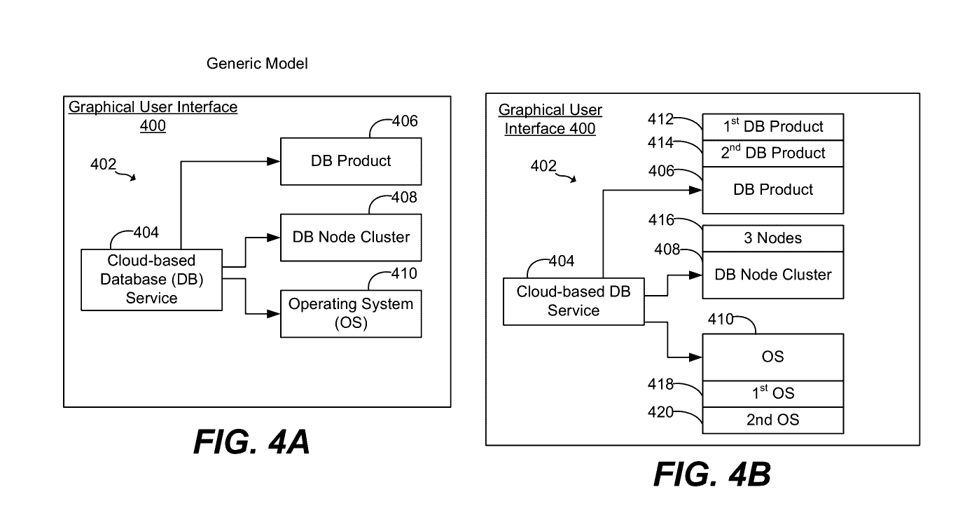

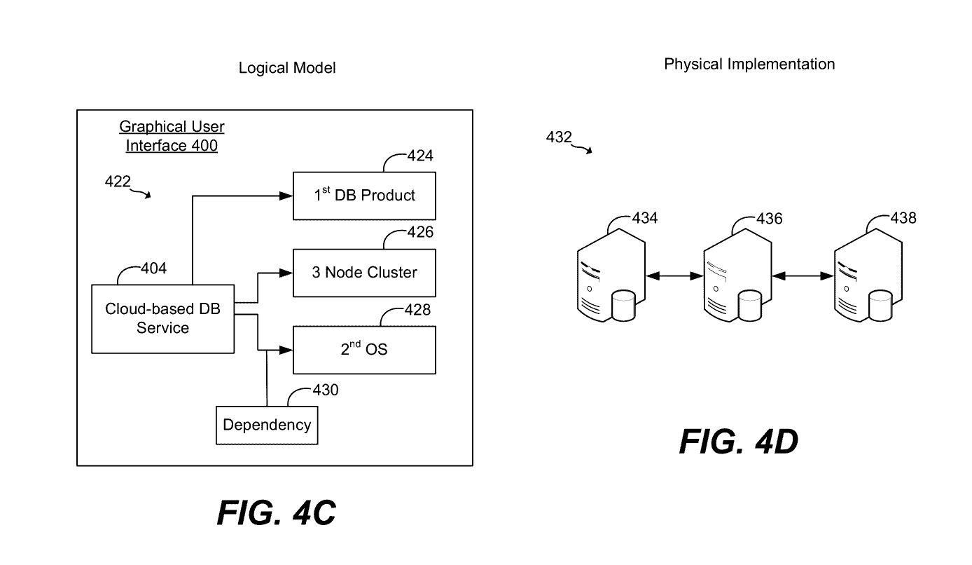

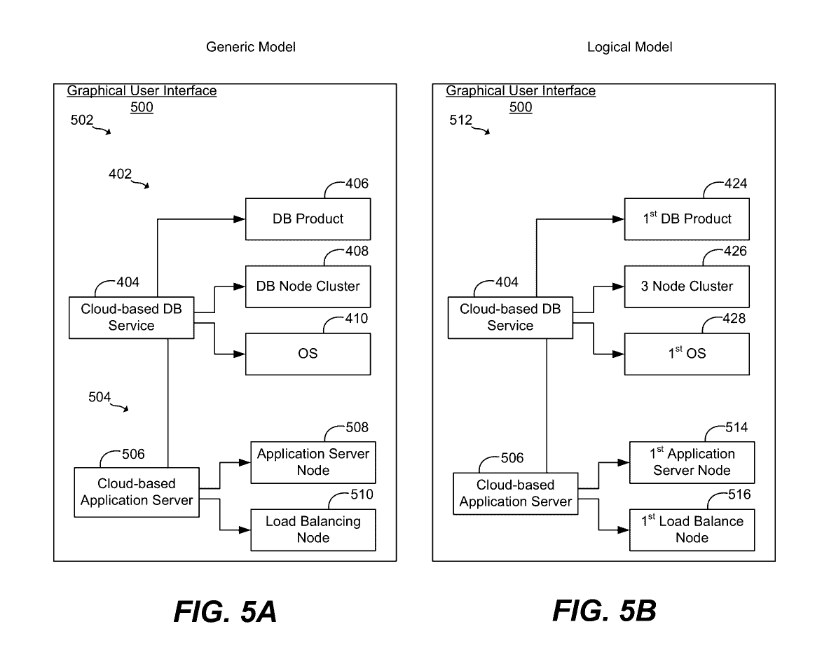

Generic model generation instructions 106 may generate a generic model of a cloud computing service based on user input. A generic model may be any abstraction or other representation of a cloud computing service that specifies a number of components included in the cloud computing service. Each component may be described in terms of a basic functionality of the component. For example, a user, such as a cloud computing service designer, may select a generic representation of a component of a cloud computing service via a graphical user interface (GUI). For example, the component may be a virtual computing component, a physical computing component, a software component, or a combination thereof. A generic representation of the component may be any descriptions of the component that are not tied to a particular vendor product. Based on selections of the user, generic mode generation instructions 106 may generate and display a generic model that includes a component of a cloud computing service via the GUI. The generic model may be independent of a technology implementation of the cloud computing service. For example, an operation system component of a generic model indicates that the operation system component corresponds to an operation system, but does not specify exactly what particular operation system product/software from a product vendor is used. Examples of a generic model are described in more detail with reference to FIGS. 4A-4B and 5A.

Logical model generation instructions 108 may generate a logical model of the cloud computing service based on the generic model. The logical model may be any abstraction or representation of a cloud computing service that specifies a particular technology implementation of each component of the cloud computing service. For example, subsequent to the generation of the generic model, the user may update a generic representation of a component of the cloud computing service to specify a technology implementation of the component via the GUI. The technology implementation may correspond to a product from a particular product vendor, such as a particular database software product from a product vendor. Based on user input, logical model generation instructions 108 may update the generic model to generate the logical model. Examples of logical models are described in more detail with reference to FIGS. 4C and 5B.

Computing resource provisioning instructions 110 may provision computing resource 112 based on the logical model. As used herein, “provision” may mean implementing the cloud computing service on a computing resource, such as computing resource 112. For example, computing resource provision instructions 110 may install and configure technology implementations as specified in a logical model on a computing resource, such as a virtual server, so that a cloud computing service may become available for use by a user. In some examples, computing resource provisioning instructions 110 may implement the cloud computing service on computing resource 112 using computing device 110. In other examples, computing resource provisioning instructions 110 may trigger another device to implement the cloud computing service on computing resource 112.

Computing resource 112 may include a physical computing device, a virtual computing device, a network, software, a cloud infrastructure, a hybrid cloud infrastructure that includes a first cloud infrastructure and a second cloud infrastructure that is different from the first cloud infrastructure, etc.

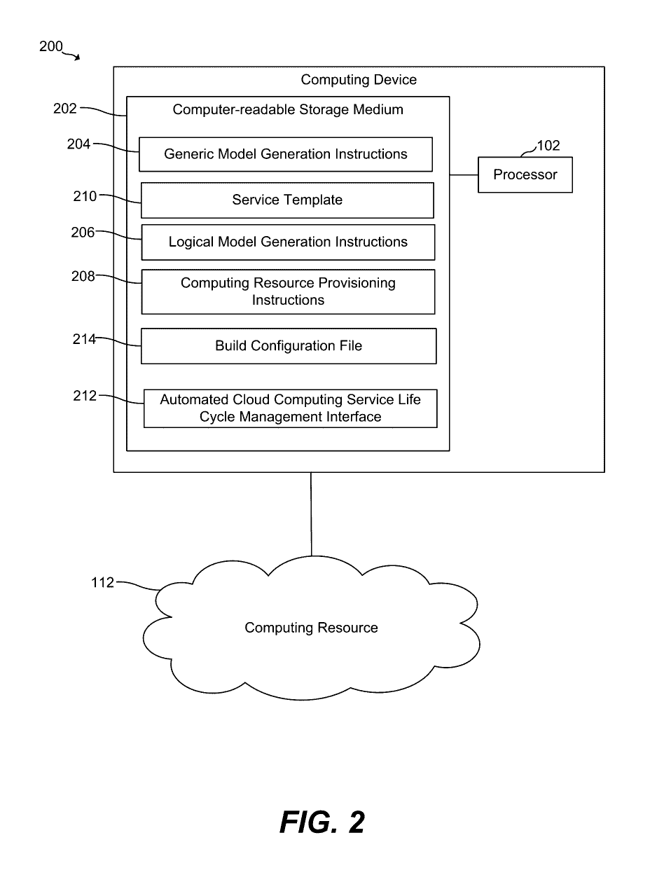

FIG. 2 is a block diagram of another example computing device 200 for provisioning computing resource 112 to implement a cloud computing service based on a generic model of the cloud computing service. As with computing device 100 of FIG. 1, computing device 200 may be any electronic device suitable for provisioning a computing resource to implement a cloud computing service based on a generic model of the cloud computing service. Computing device 200 may include processor 102 and a computer-readable storage medium 202. Computer-readable storage medium 202 may be similar to computer-readable storage medium 104 of FIG. 1. As described in more detail below, computer-readable storage medium 202 may be encoded with a series of processor executable instructions 204, 206, and 208 for generating a generic model, generating a logical model based on the generic model, and provisioning a computing resource to implement a cloud computing service based on the logical model.

Generic model generation instructions 204 may generate a generic model of a cloud computing service using a service template 210 stored in computer-readable storage medium 202. In some examples, service template 210 may correspond to a generic model that includes a generic representation of a particular component, such as a commonly used component of a cloud computing service. As an example, service template 210 may correspond to a generic model of a database server service that includes a generic representation of a database product, a generic presentation of a database server, and a generic representation of a database. In some other examples, service template 210 may correspond to a particular generic model that includes a generic representation of a component previously selected by a user.

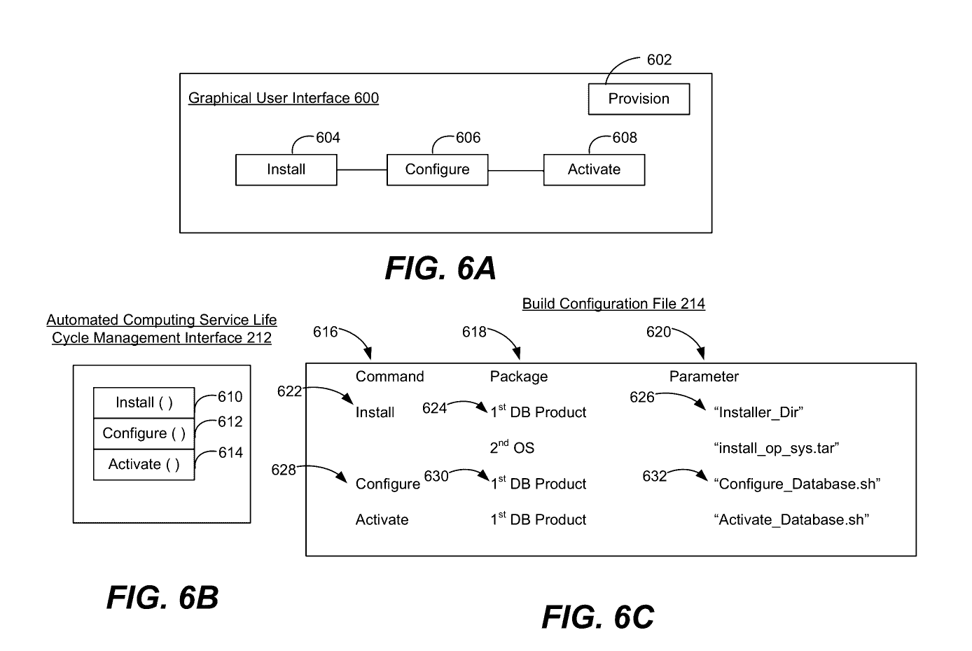

Logical model generation instructions 206 may generate a logical model based on the generic model similar to the logical model instructions 108 of FIG. 1. Computing resource provisioning instructions 208 may provision computing resource 112 to implement the cloud computing service based on the logical model. In some examples, computing resource provisioning instructions 208 may provision computing resource 112 using an automated cloud computing service life cycle management interface 212 stored in computer-readable storage medium 202. Automated cloud computing service life cycle management interface 212 may be an application programming interface (API) that enables provisioning of a computing resource, such as computing resource 112. Automated cloud computing service life cycle management interface 212 may provision a computing resource based on a build configuration file 214 stored in computer-readable storage medium 202. Build configuration file 214 may be a file that provides correlations between an application programming interface (API) that is not specific to any product vendors and product vendor specific APIs. An example of automated cloud computing service life cycle management interface 212 and an example of build configuration file 214 are described in more detail with reference to FIGS. 6B and 6C, respectively.

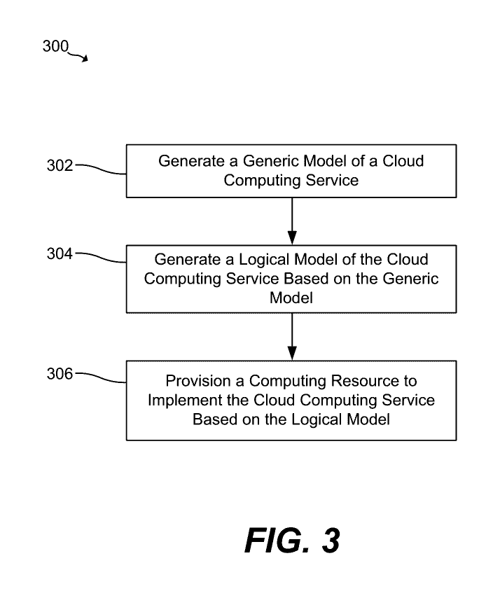

FIG. 3 is an example of a flowchart illustrating a method 300 of provisioning a computing resource, such as computing resource 112 of FIGS. 1 and 2, to implement a cloud computing service based on a generic model of the cloud computing service. Method 300 may be implemented using computing device 100 of FIG. 1 and/or computing device 200 of FIG. 2. Method 300 includes generating a generic model of a cloud computing service, at 302. For example, generic model generation instructions 106 may generate a generic model of a cloud computing service.

Method 300 also includes generating a logical model of the cloud computing service based on the generic model, at 304. For example, logical model generation instructions 108 may generate a logical model of the cloud computing service based on the generic model. Method 300 further includes provisioning a computing resource to implement the cloud computing service based on the logical model, at 306. For example, computing resource provisioning instructions 110 may provision computing resource 112 based on the logical model.

FIG. 4A is a diagram of an example graphical user interface (GUI) 400 of a cloud computing service design application in which a generic model 402 of a cloud computing service is displayed. GUI 400 may be displayed, for example, by computing devices 100, 200 as part of a process used to enable a user, such as a cloud computing service designer, to design a generic model of a cloud computing service. For example, generic model 402 may correspond to a generic representation of a component of a cloud-based database (DB) service. In other examples, generic model 402 may correspond to a generic representation of a component of another cloud computing service.

Generic model 402 may include a service entry point 404, a DB product 406, a DB node cluster 408, and an operating system (OS) 410. Service entry point 404 may define a type of cloud computing service. For example, service entry point 404 may correspond to a cloud-based DB service. DB product 406, DB node cluster 408, and OS 410 may correspond to generic representations of components of a cloud computing service as defined by service entry point 404. For example, DB product 406 may correspond to a generic representation of a DB product of the cloud-based DB service. DB node cluster 408 may correspond to a generic representation of DB node cluster of the cloud-based DB service. OS 410 may correspond to a generic representation of an OS used to run DB product 406.

Generic model 402 may be independent of a particular technology implementation of the cloud-based DB service. For example, DB product 406, DB node cluster 408, and OS 410 may be independent of particular technology implementations used to implement the cloud-based DB service. Thus, a cloud computing service designer may design a cloud computing service without concerning implementation details of the cloud computing service. Accordingly, design complexity may be reduced. Further, generic model 402 may be reused for subsequent cloud-based DB service deployments for customers since generic model 402 may be independent of a particular technology implementation. Accordingly, design cost may be reduced.

In some examples, a cloud computing service designer may use a cloud computing service design application to generate generic model 402 by selecting a service entry point, such as service entry point 404, and generic representations of components of a cloud computing service, such as DB product 406, DB node cluster 408, OS 410, or any combination thereof. In other examples, a cloud computing service designer may generate generic model 402 by using a service template. A service template may correspond to a generic model of a cloud computing service that includes a particular component, such as a commonly used component. Thus, in this specific example, a cloud computing service designer may generate generic model 402 by selecting a particular service template to generate the generic model. The particular service template may be selected from a list of available service templates displayed on GUI 400. In other examples, after a cloud computing service designer completes designing a particular generic model, the cloud computing service designer may save the particular generic model as a service template for subsequent use.

FIG. 4B is a diagram of an example GUI 400 of a cloud computing service design application in which a logical model of a cloud computing service is being generated based on generic model 402 of FIG. 4A. Subsequent to completion of generic model 402, a logical model that corresponds to a particular technology implementation of the cloud-based DB service may be generated based on a customer's preference and/or access to technologies. In some examples, the logical model may be generated during run time, such as a period during which the cloud-based DB service is to be deployed. The logical model may be generated based on generic model 402. The logical model is described in more detail with reference to FIG. 4C.

Technology implementations of DB product 406, DB node cluster 408, and OS 410 may be selected from among a set of displayed options to generate the logical model. For example, when DB product 406 is selected by a cloud computing service designer via an input device, DB product implementations 412 and 414 may be displayed, such that the cloud computing service designer may select one of the DB product implementations 412 and 414. DB product implementation 412 may correspond to a first DB product and DB product implementation 414 may correspond to a second DB product. The first DB product and the second DB product may be from the same product vendor or different product vendors. When DB node cluster 408 is selected, cluster implementation 416 may be display. Cluster implementation 416 may correspond to a particular number of nodes in a cluster, such that the cloud computing service designer may specify three nodes to be included in a cluster. When OS 410 is selected, OS implementations 418 and 420 may be displayed, such that the cloud computing service designer may select one of the OS implementations 418 and 420. OS implementation 418 may correspond to a first OS product and OS implementation 20 may correspond to a second OS product. After selections of technology implementations of each component of generic model 402, generation of the logical model is complete.

In some examples, technology implementations of a particular component may be dependent on a selection of a technology implementation of another component. For example, OS implementation 420 may not be compatible with DB product implementation 412. When DB product implementation 412 is selected, OS implementation 420 may not be displayed.

FIG. 4C is a diagram of an example GUI 400 of a cloud computing service design application in which a logical model 422 generated based on generic model 402 of FIG. 4A is displayed. Logical model 422 may include technology implementations 424, 426, 428. Technology implementation 424 may correspond to a technology implementation (DB production implementation 412 of FIG. 4A) of DB product 406 selected by the cloud computing service designer. Technology implementation 426 may correspond to a technology implementation of DB node cluster 408 selected by the cloud computing service designer, such as cluster implementation 416. Technology implementation 428 may correspond to a technology implementation of OS 410 selected by the cloud computing service designer, such as OS implementation 420. After logical model 422 is generated, the cloud computing service designer may provision a computing resource to implement a cloud computing service that corresponds to logical model 422.

In some examples, a provisioning dependency 430 between components may be specified. Provisioning dependency 430 may indicate a first component has priority during a provisioning process over a second component. For example, the cloud computing service designer may specify provisioning dependency 430 in logical model 422. Provisioning dependency 430 may indicate that technology implementation 428 is to be configured prior to configuring technology implementation 424 during the provisioning process. In some examples, after logical model 422 is generated, an associated build configuration file, such as build configuration file 214 of FIG. 2, may be generated to be used by automated computing service life cycle management interface 212 to provision a computing resource.

FIG. 4D is a diagram of an example physical implementation 432 of logical model 422 of FIG. 4C. Physical implementation 432 may correspond to a computing resource provisioned to implement the cloud-based DB service. For example, physical implementation 432 may include a first server 434, a second server 436, and a third server 438. Servers 434-438 may be arranged in a cluster configuration as specified in technology implementation 426. Each of servers 434-438 may be provisioned to run an OS and a DB product as specified by technology implementations 424 and 428, respectively.

FIG. 5A is a diagram of an example GUI 500 of a cloud computing service design application in which a generic model 502 that is generated based on a first generic model and based on a second generic model is displayed. In some examples, the first generic model may be the same as the second generic model. In other example, the first generic model may be different from the second generic model.

As an example, generic model 502 may be a combination of generic model 402 of FIG. 4A and a generic model 504. Generic model 504 may correspond to a generic representation of a component of a cloud-based application server. Generic model 504 may include a service entry point 506, an application server node 508, and a load balancing node 510. Accordingly, generic model 502 may correspond to a generic representation of a component of a cloud-based computing service that includes a DB service and an application server. Thus, a generic model of a more complex cloud computing service may be generated by combining different generic models.

FIG. 5B is a diagram of an example GUI 500 of a cloud computing service design application in which a logical model 512 generated based on generic model 502 of 5A is displayed. Logical model 512 may be generated in a similar manner as logical model 422 of FIG. 4C. Logical model 512 may include technology implementations 424, 426, 428, 514, and 516. Technology implementation 514 may correspond to a technology implementation of application server node 508 and technology implementation 516 may correspond to a technology implementation of load balancing node 510. After logical model 512 is generated, a computing resource may be provisioned to implement the cloud-based computing service that includes a DB service and an application server based on logical model 512.

FIG. 6A is a diagram of an example GUI 600 of a cloud computing service design application in which a provisioning process of a cloud computing service is displayed. After a logical model, such as logical model 422 or logical model 512, is generated, the cloud computing service designer may use automated computing service life cycle management interface 212 to provision the computing resource.

Automated computing service life cycle management interface 212 may enable the cloud computing service designer to provision the computing resource with a single input, such as a single click from a mouse. For example, a provision button 602 may be displayed on GUI 600. The cloud computing service designer may select provision button 602 via a single mouse click to activate automated computing service life cycle management interface 212 to provision the computing resource. When automated computing service life cycle management interface 212 is provisioning the computing resource, progress of a provisioning process may be displayed on GUI 600. For example, GUI 600 may display an install stage 604 of the provisioning process, a configure stage 606 of the provisioning process, and a activate stage 608 of the provisioning stage. Thus, the cloud computing service designer may be aware of the progress of the provisioning process.

FIG. 6B is a diagram of an example automated cloud computing service life cycle management interface 212. Automated cloud computing service life cycle management interface 212 may be a set of canonical application programming interface (API) for run time services that is independent of vendor products (i.e., not specific to a particular vendor product).

Automated cloud computing service life cycle management interface 212 may include a plurality of generic APIs. For example, automated cloud computing service life cycle management interface 212 may include a generic install API 610, a generic configure API 612, and a generic activate API 614. When generic install API 610 is invoked, generic install API 610 may install a technology implementation of a component, such as technology implementation 424, onto a file system. When generic configure API 612 is invoked, generic configure API 612 may configure a setting of the technology implementation of the component. When generic activate API 614 is invoked, generic activate API 614 may make the technology implementation of the component available for use. Although automated cloud computing service life cycle management interface 212 may be independent of vendor products, automated cloud computing service life cycle management interface 212 may be compatible with a plurality of technology implementations from different vendor products by using build configuration file 214. Build configuration file 214 is described in more detail with reference to FIG. 6C.

FIG. 6C is a diagram of an example build configuration file 214. Build configuration file 214 may be generated when a logical model is generated, such as logical model 422. Automated cloud computing service life cycle management interface 212 may use build configuration file 214 to determine parameters associated with each stage of a provisioning process of a computing resource. For example, when generic install API 610 is invoked, generic install API 610 may use build configuration file 214 to identify a technology implementation to be installed and installation details of the technology implementation.

Build configuration file 214 may include API entries that correspond to generic APIs to be invoked under a command column 616. Build configuration file 214 may also include package entries under a package column 618 and parameter entries under a parameter column 620. Each API entry may be associated with a corresponding package entry and/or a parameter entry. A package entry may identify a technology implementation to be used by a corresponding generic API. A parameter entry may identify how the technology implementation is to be used. For example, a parameter entry may identify how the technology implementation is to be installed. As another example, a parameter entry may identify how the technology implementation is to be configured. An API entry 622 may correspond to generic install API 610, a package entry 624 associated with API entry 622 may indicate that a first DB product is to be installed when generic install API 610 is invoked. A parameter entry 626 associated with API entry 622 may indicate that generic install API 610 may access a directory “Installer_Dir” to install the first DB product. When generic install API 610 is invoked during run time, package entry 624 and/or parameter entry 626 may be applied as an attribute of generic install API 610 to bind or provision the first DB product to a computing resource.

As another example, an API entry 628 may correspond to generic configure API 612. A package entry 630 associated with API entry 628 may indicate that generic configure API 612 is to configure the first DB product. A parameter entry 632 associated with API entry 628 may indicate that generic configure API 612 may access a script “Configure_{——}Database.sh” to configure the first DB product. Thus, by using build configuration file 214 and automated cloud computing service life cycle management interface 212, coding by the cloud computing service designer to provision a computing resource may be avoided.

According to the foregoing, example embodiments disclosed herein enable a cloud computing service designer to design a cloud computing service using a generic model of the cloud computing service. The generic model may be independent of a technology implementation of the cloud computing service. The service designer may generate a logical model of the cloud computing service based on the generic model so that a computing resource may be provisioned based on the logical model to implement the cloud computing service. Thus, the cloud computing service may be provisioned into a number of different heterogeneous architectures.

What is claimed is:

1. A computing device comprising:
a processor to:
generate a generic model of a cloud computing service, wherein the generic model is independent of a technology implementation of the cloud computing service;
generate a logical model of the cloud computing service based on the generic model; and
provision a computing resource to implement the cloud computing service based on the logical model.

2. The computing device of claim 1, the processor further to:
provision the computing resource using an automated cloud computing service life cycle management interface, wherein the automated cloud computing service life cycle management interface is compatible with a plurality of technology implementations from different vendors; and
apply a technology implementation associated with the logical model as an attribute to the automated cloud computing service life cycle management interface during run time to bind the technology implementation to the computing resource.

3. The computing device of claim 1, wherein the generic model includes a generic representation of a component of the cloud computing service, and wherein the component corresponds to a virtual computing component, a physical computing component, a software component, or a combination thereof.

4. The computing device of claim 1, wherein the logical model corresponds to a particular technology implementation of the cloud computing service, and wherein the particular technology implementation includes a technology implementation of a component of the cloud computing service.

5. The computing device of claim 1, the processor further to generate the generic model based on a service template.

6. The computing device of claim 1, the processor further to:
generate a particular generic model of a particular cloud computing service based on a first generic model of a first cloud computing service and based on a second generic model of a second cloud computing service, wherein the first cloud computing service is different from the second cloud computing service.

7. The computing device of claim 1, wherein the computing resource is to be provisioned based on a build configuration file.

8. The computing device of claim 1, wherein the computing resource includes a first cloud infrastructure and a second cloud infrastructure, and wherein the first cloud infrastructure is different from the second cloud infrastructure.

9. A method comprising:
generating, at a computing device executing a cloud computing service design application, a generic model of a cloud computing service, wherein the generic model is independent of a technology implementation of the cloud computing service;
generating, at the computing device executing the cloud computing service design application, a logical model of the cloud computing service based on the generic model, wherein the logical model corresponds to a particular technology implementation of the cloud computing service; and
provisioning, at the computing device executing the cloud computing service design application, a computing resource based on the logical model to implement the cloud computing service.

10. The method of claim 9, wherein provisioning the computing resource includes provisioning the computing resource using an automated cloud computing service life cycle management interface, wherein the automated cloud computing service life cycle management interface is compatible with a plurality of technology implementations from different vendor products, and wherein a technology implementation associated with the logical model is applied as an attribute to the automated cloud computing service life cycle management interface during run time to bind the technology implementation to the computing resource.

11. The method of claim 9, wherein generating the generic model includes generating the generic model based on a service template, and wherein generating the logical model includes generating the logical model based on a parameter associated with a component of the cloud computing service and based on the generic model.

12. The method of claim 9, wherein provisioning the computing resource includes provisioning the computing resource based on a build configuration file.

13. The method of claim 9, wherein generating the logical model of the cloud computing service includes specifying a dependency of components of the cloud computing service.

14. A non-transitory computer-readable storage medium comprising instructions when executed cause a processor of a computing device to:
generate a generic model of a cloud computing service, wherein the generic model is independent of a technology implementation of the cloud computing service;
generate a logical model of the cloud computing service based on the generic model; and
provision a computing resource to implement the cloud computing service based on the logical model and based on a build configuration file.

15. The non-transitory computer-readable storage medium of claim 14, wherein the logical model corresponds to a particular technology implementation of the cloud computing service.
